(19) United States
(12) Patent Application Publication
(10) Pub. No.: US 2008/0120383 A1
(43) Pub. Date: May 22, 2008

(54) METHOD AND SYSTEM FOR PREVENTING THREAD INSERTION OR REMOVAL

(76) Inventors: Shruti Kumar, Littleton, MA (US); Patrick Joseph O'Sullivan, Dublin (IE); Niklas Heidloff, Salzkotten (DE); Michael R. O'Brien, Westford, MA (US)

Correspondence Address: LOTUS AND RATIONAL SOFTWARE;David A. Dagg, Esq., 44 Chapin Road, Newton, MA, 02459, US

(21) Appl. No.: 11/562,465

(22) Filed: Nov. 22, 2006

(51) Int. Cl. G06F 15/82

(52) U.S. Cl. 709/206

(57) ABSTRACT

A method and system for preventing recipients from being added and/or removed from a message thread in an e-mail and/or calendaring application. Recipients of a thread message may be allowed to seek and obtain permission from a thread originator to insert a recipient to and/or remove a recipient from the thread. The originating user of a message thread can prevent insertion and/or removal of recipients in an e-mail message thread and/or a calendaring system invitation message by selecting from corresponding message composition user interface options. A mechanism persistently registers the recipient removal and/or insertion settings provided by the originating user, for example as settings stored in and conveyed with the messages themselves. The originating user can permit non-originating users to insert and/or remove recipients from the thread. The originating user can select an option in the message composition user interface that requires and/or allows non-originating users to request permission to insert and/or remove a recipient to a thread. The permission request is forwarded to the originating user, who can then accept or reject the request. The originating user can also expressly list or otherwise indicate which user(s) cannot be inserted into the message thread, and/or which recipients cannot be removed from the message thread.

### FIELD OF THE INVENTION

The present invention relates generally to electronic mail (“e-mail”) and calendar event scheduling software technology, and more specifically to a method and system for preventing insertion or removal of recipients for a message thread.

### BACKGROUND OF THE INVENTION

Electronic mail (“e-mail”) systems are an integral part of today's communication infrastructure for businesses and individuals. In many circumstances, discussions between users performed using e-mail messages result in the formation of what are generally referred to as message “threads”. In an e-mail message thread, recipients of an original message and subsequent replies can participate in the discussion by replying to all recipients of the thread, e.g. all users listed in either the “TO:” or “CC:” field. In existing systems, new recipients are sometimes added to and/or removed from the set of recipients as reply messages are issued within the thread. Such additions and/or removals of recipients are outside the control of the user sending or the original message on which the thread is based. However, in many situations, for example due to the confidential nature of information or other legitimate business requirements, it becomes important to have some restrictions and/or control imposed over the addition and/or removal of recipients in the thread.

For example, in the case where a user A sends an e-mail message to users B and C. User B uses a “REPLY TO ALL” feature to send a reply message to both user A and user B, and also includes in the recipient list an additional user D. User C then replies to user B's reply message, again using the “REPLY TO ALL” feature, with the result that user D is included in the recipients for user C's reply, and in recipients to all subsequent replies generated to C's reply that are generated using the “REPLY TO ALL” feature. In this way, user D has been added into the conversation being held through the message thread. However, user A, who was the user that generated the original or “root” message of the thread, may have desired that receipt of messages in the thread be kept limited to the three users A, B and C. Existing systems provide no way for user A to conveniently and effectively enforce such a limitation. This problem is also specifically exemplified in the case of electronic calendar event invitations, which are often conveyed using e-mail messages or the like. Existing systems allow for users to add other users to the list of recipients of a calendar event invitation, and then forward the invitation to the expanded recipient list. This prevents an originator of the calendar event invitation from limiting receipt of the invitation to only those users listed as recipients in the original invitation. The standard e-mail client systems, such as Lotus Notes® of International Business Machines, Armonk N.Y., Microsoft Outlook® of Microsoft Corporation, Redmond Wash., and Internet based e-mail systems such as those provided by Yahoo!® and Google® do not effectively address this problem.

For the above reasons and others it would therefore be desirable to have a new system for providing e-mail communications that enables an originator of a message thread to control the recipients of messages in the thread in terms of whether recipients can be inserted and/or removed without permission.

### SUMMARY OF THE INVENTION

To address the above described and other shortcomings of previous solutions, a method and system for preventing recipients from being added to and/or removed from a message thread is disclosed. The disclosed system may be embodied in e-mail and/or electronic calendaring and scheduling applications. The disclosed system may further be embodied to allow a recipient of a thread message to seek and obtain permission from a thread originator to add a recipient to and/or remove a recipient from the thread.

The disclosed system enables an originating user of a message thread to prevent addition and/or removal of recipients in the context of an e-mail message thread and/or a calendaring system invitation message thread. In one embodiment, the message composition user interface includes display objects that enable a user to select from at least the following thread recipient insertion/deletion control options: 1) “Prevent recipient insertion”, and/or 2) “Prevent recipient removal”. When thread recipient insertion/deletion control options are selected by the originator of an e-mail message or a calendaring system invitation, the disclosed system operates to appropriately control the addition and/or removal of recipients in the message thread. The controls over recipient insertion and/or removal provided by the disclosed system are desirable in situations in which an originating user wants to limit the audience of an e-mail thread, and/or the attendee list of a calendar event, and wants to automatically enforce boundaries on other users in this regard.

The disclosed system provides a mechanism for persistently registering the recipient removal and/or insertion settings provided by the originating user, for example as settings stored in and conveyed with the messages themselves.

In another aspect of the disclosed system, the originating user can permit non-originating users to insert and/or remove recipients from the thread. In one embodiment, the originating user can select an option in the message composition user interface that requires non-originating users to request permission to insert a recipient into and/or remove a recipient from a message thread. The requests sent from non-originating users are forwarded to the originating user, who can then accept or reject the requests.

In another aspect of the disclosed system, the originating user can expressly list or otherwise indicate which user or users cannot be added as recipients into the message thread, and/or which recipients cannot be removed from the message thread.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram showing software and hardware components in an illustrative embodiment of the disclosed system;

FIG. 2 is a simplified screen shot showing an example of a new message composition user interface generated in an illustrative embodiment of the disclosed system;

FIG. 3 is a simplified screen shot showing an example of a delivery options user interface generated in an illustrative embodiment of the disclosed system;

FIG. 4 is a flow chart showing steps performed to send a message including thread recipient insertion/deletion flags in an illustrative embodiment;

FIG. 5 is a flow chart showing steps performed to prevent thread recipient insertion in an illustrative embodiment of the disclosed system;

FIG. 6 is a flow chart showing steps performed to prevent thread recipient removal in an illustrative embodiment of the disclosed system; and

FIG. 7 is a flow chart showing steps performed to require recipients to seek permission to insert/remove thread recipients.

### DETAILED DESCRIPTION OF EXEMPLARY EMBODIMENTS

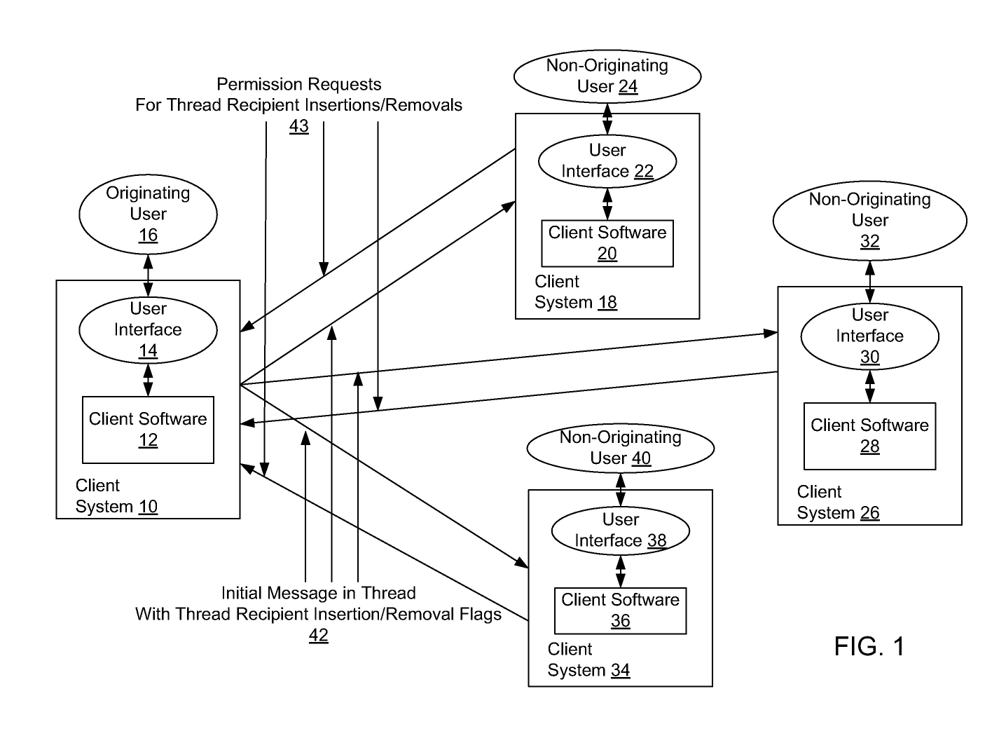

As shown in FIG. 1, hardware and software components in an operational environment including an illustrative embodiment of the disclosed system include client systems 10, 18, 26 and 34. Each of the client systems 10, 18, 26 and 34 includes communication application client software, shown for purposes of illustration as client software 12 in client system 10, client software 20 in client system 18, client software 28 in client system 26, and client software 36 in client system 34. The communication application client software in each of the client systems of FIG. 1 generates a user interface for a corresponding user, shown as user interface 14 generated by client software 12 for the originating user 16, user interface 22 generated by client software 20 for the non-originating user 24, user interface 30 generated by the client software 28 for the non-originating user 32, and user interface 38 generated by the client software 36 for the non-originating user 40.

The user interfaces 14, 22, 30, and 38 may be embodied as any specific type of user interface. For example, in one embodiment, the client software 12, 20, 28 and 36, may be made up of dedicated client software associated with a communication application program, such as an electronic mail (“e-mail”) application program, or a calendaring and scheduling application program, and provide a user interface associated with that communication application program as part of a multi-window graphical user interface. Alternatively, the client software 12, 20, 28 and 36, may be made up of Web browser programs operable to provide user interfaces to a Web-based e-mail and/or calendaring and scheduling application program within a multi-window graphical user interface. The user interfaces generated by the client software components shown in FIG. 1 may be navigated using any specific type of user interface device in their respective client system, such as a computer keyboard or mouse, and/or using voice commands or the like.

The client systems 10, 18, 26 and 34 shown in FIG. 1 may each be embodied as a computer system including, for example, at least one processor, program storage, such as memory, for storing program code executable on the processor, one or more input/output devices and/or interfaces, such as data communication and/or peripheral devices and/or interfaces, and may each further include appropriate operating system software. The client systems 10, 18, 26 and 34 may include any specific type of computer system or other type of client device, such as, for example, desktop computer systems, PDAs (Personal Digital Assistants), cell phones, tablet PCs, or any other appropriate device capable of providing user interfaces to a user. The client computer systems 10, 18, 26 and 34 of FIG. 1 are communicably interconnected through a data communication network, such as the Internet, a Local Area Network (LAN), or any other specific type of communication system or network.

Those skilled in the art will recognize that while only four client systems are shown in FIG. 1 for purposes of concise illustration, the disclosed system is not limited to any specific number of interconnected computer systems. Accordingly, the disclosed system may be embodied to support operation using any specific number of communicable computer systems.

Moreover, while client computer systems are shown in the illustrative embodiment of FIG. 1, the disclosed system is not limited to such an embodiment. Accordingly, the functions described in connection with operation of the client systems shown in FIG. 1 may alternatively be performed partly or wholly within one or more server computer systems and software components executing thereon.

During operation of the illustrative embodiment shown in FIG. 1, the originating user 16 composes an initial message 42 using features provided through the user interface 14. The initial message 42 composed by the originating user 16 may, for example, be an initial or original message on which a message thread is based. A message thread based on the initial message 42 composed by the originating user 16 is, for example, made up of that initial message 42 and a number of subsequent reply messages generated by recipients of that initial message, and potentially also by the originating user 16. The initial message composed by the originating user 16 may also be referred to as the “root message” of a message thread built on that message. The recipients of the initial message 42 in the example of FIG. 1 are shown including the non-originating user 24, the non-originating user 32, and the non-originating user 40.

The initial message 42 includes a number of thread recipient insertion/deletion control flags. The thread recipient insertion/deletion control flags contained in the initial message 42 control whether recipients can be added to or removed from the recipient list for the initial message 42. The thread recipient insertion/deletion control flags in the initial message 42 are selected or otherwise indicated by the originating user 16. In one embodiment, the thread recipient insertion/deletion control flags in the initial message 42 are MIME (Multipurpose Internet Mail Extension) flags or the like contained in the initial message 42.

In one embodiment of the disclosed system, the thread recipient insertion/deletion control flags in the initial message 42 allow non-originating users to request permission from the originating user 16 to add a recipient into and/or delete a recipient from the recipient list contained in the initial message 42. When such control flags are set in the initial message 42, the non-originating users 24, 32 and 40 can issue permission request messages 43 that are sent to the originating user 16. When the permission requests 43 are received by the client system 10, the originating user 16 is provided with a user interface screen that enables the originating user 16 to either allow or disallow the requested recipient addition and/or removal. In the event that the originating user 16 allows a request to add a recipient into and/or remove a recipient from the recipient list contained in the initial message 42, an approval message for that request is sent to the client system of requesting non-originating user, which then operates to allow the non-originating user to perform the recipient insertion or removal for which permission was sought. In the event that the originating user 16 disallows the requested recipient insertion and/or removal, a rejection message for that request is sent to the client system of the requesting non-originating user, which then operates to prevent the non-originating user from performing the recipient insertion or removal for which permission was sought.

Controls over recipient insertion and/or deletion are maintained beyond first order replies to the initial message 42, and extend to all subsequent messages generated in the message thread based on the initial message 42. For example, the initial message 42 may be addressed to the set of recipients consisting of the non-originating user 24, the non-originating user 30, and the non-originating user 40. After the initial message 42 is received by the non-originating user 32, the non-originating user 32 may use a REPLY TO ALL feature of the communication system to generate a new message based on the initial message 42. That new message would accordingly be sent from the non-originating user 32 to each of the non-originating user 24, the non-originating user 40, and the originating user 16. The new message generated by the non-originating user 32, and sent using the REPLY TO ALL feature, is an example of a message in the message thread based on the initial message 42. The new message based generated by the non-originating user 32, and based on the initial message 42, is generated such that it includes the recipient insertion/removal control flags from the initial message 42.

When the new message generated by the non-originating user 32 is received, the non-originating user 24 may generate another new message in the thread using the REPLY TO ALL feature of the communication system. The non-originating user 32 may attempt to add a recipient to or remove a recipient from the set of recipients indicated by the initial message 42. However, since the thread recipient insertion/deletion control flags contained in the initial message 42 are also sent with each subsequent message contained in the message thread based on the initial message 42, the settings of those flags are used by the client software 20 to control such attempted recipient insertion/removal operations.

For example, when the non-originating user 24 generates a reply to the reply generated by the non-originating user 32, for example again using the REPLY TO ALL feature, the communication system will initially set up the message such that the recipients are the originating user 16, the non-originating 32, and the non-originating user 40. If the non-originating user 24 then attempts to remove one of those recipients, or attempts to add a new recipient, the client software 20 will check whether the attempted operation is permitted, based on the thread recipient insertion/removal control flags contained in the reply message to the initial message 42, and received from the non-originating user 32. The recipient insertion/removal control flats in the reply to the initial message 42 were copied from the initial message 42. Accordingly, whether the non-originating user 24 is permitted to remove or add a recipient to the message recipients list is determined based on the settings of the recipient insertion/deletion flags contained in the reply of non-originating user 32 to the initial message 42, which were in turn copied from the recipient insertion/removal control flags contained in the initial message 42.

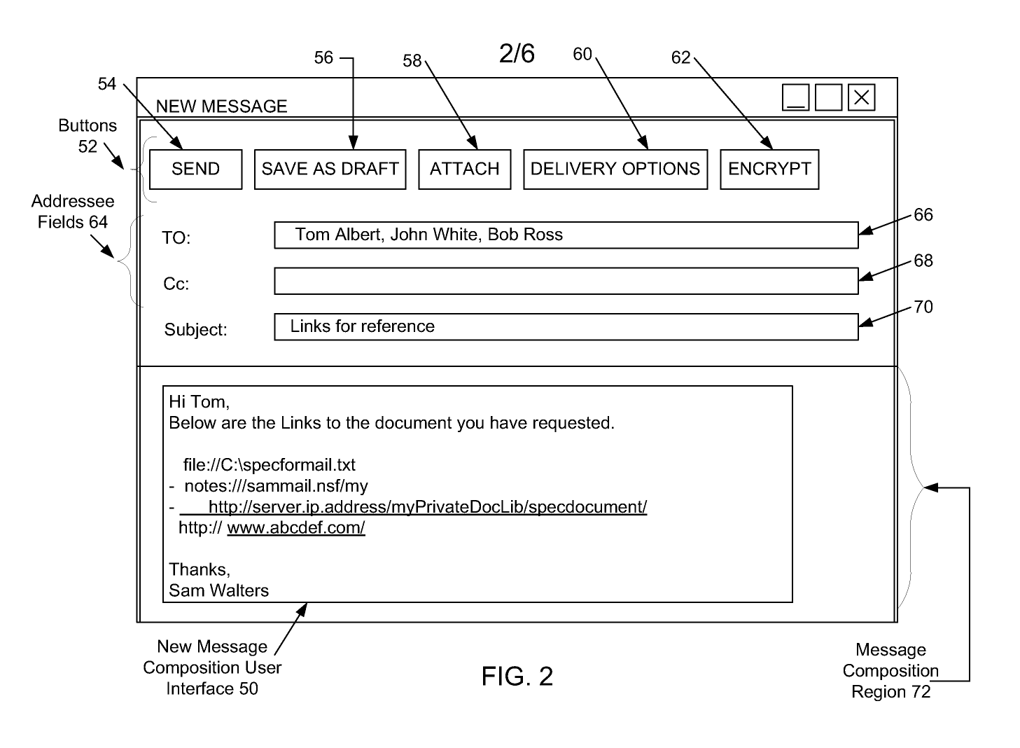

FIG. 2 is a simplified screen shot showing an example of a new message composition user interface 50 generated in an illustrative embodiment of the disclosed system. The user interface 50 is an example of at least part of the user interface 14 displayed to the originating user 16 by the client software 12, and enables the originating user 16 to compose the initial message 42 shown in FIG. 1.

As shown in FIG. 2, the user interface 50 includes a number of buttons 52 that enable the user to control functions performed by the client software, for example by clicking on the corresponding button using the mouse. The buttons 52 include a SEND button 54 that enables the user to send the message they have composed, a SAVE AS DRAFT button 56 that enables the user to save the composed message as a draft, an ATTACH button 58 that enables the user to attach a document to the message, a DELIVERY OPTIONS button 60 that enables the user to access a number of delivery options to be associated with the message, and an ENCRYPT button 62 that enables the user 16 to cause the message to be encrypted.

The new message composition user interface 50 further includes addressee fields 64. The addressee fields 64 enable the user to list the recipients for the message. Using the features of the disclosed system, accessed through the button 60, the originating user 16 can control whether users are added to or removed from the set of recipients entered by the originating user 16, when subsequent replies are generated in a message thread based on the message being composed using the user interface 50. In the embodiment shown in FIG. 2, the addressee fields 64 include a To: field 66 and a Cc: (“Carbon Copy”) field 68. The disclosed system is not limited to embodiments including the specific addressee fields 64 shown in FIG. 2, but may alternatively be embodied using any specific set of address fields.

Further shown in the new message composition user interface 50 is a Subject: field 70 for the originating user 16 to enter a subject line into with regard to the message being composed, and a message composition region 72 that enables the originating user 16 to enter text and/or other content to be included in the message being composed using the user interface 50.

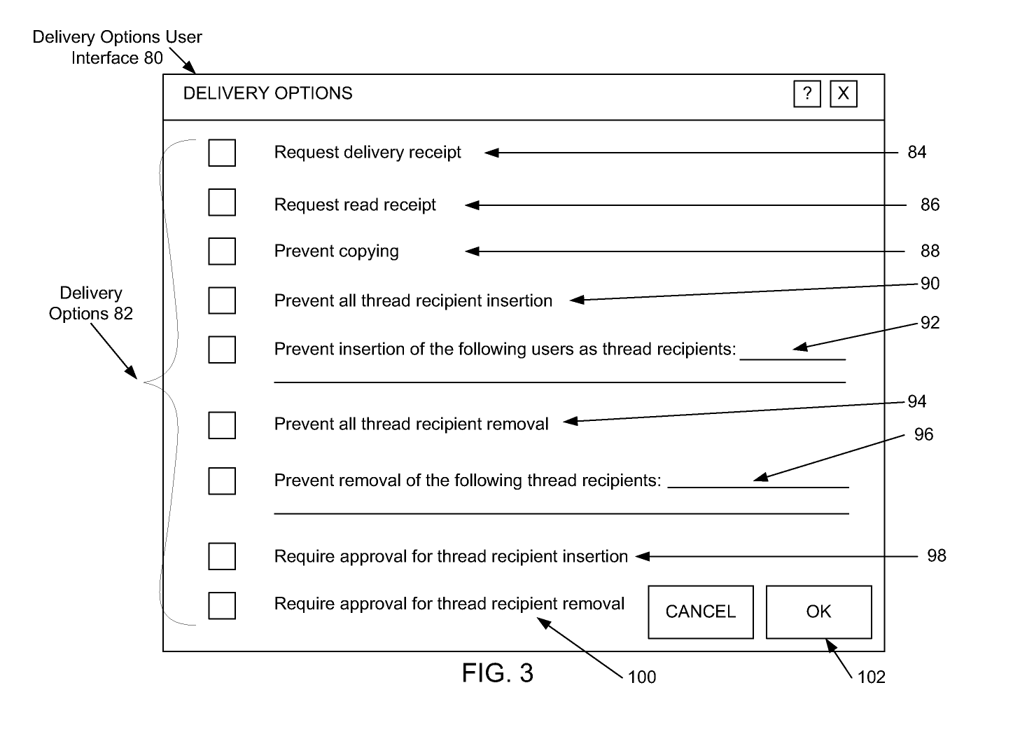

FIG. 3 is a simplified screen shot showing an example of a delivery options user interface 80 generated in an illustrative embodiment of the disclosed system, for example to the originating user 16 of FIG. 1 in response to the originating user 16 clicking on the button 60 in the user interface 50 shown in FIG. 2. As shown in FIG. 3, the delivery options user interface 80 includes delivery options 82. Each of the delivery options 82 enables the originating user 16 to control an aspect of the delivery of the message composed using the user interface 50 shown in FIG. 2. While the delivery options 82 are shown as being provided through check boxes in the illustrative embodiment of FIG. 3, enabling the originating user 16 to select individual options by clicking on the corresponding check box, the disclosed system is not limited to such an embodiment. Accordingly, any specific type of user interface construct may be used in the alternative to allow the originating user 16 to indicate which of the delivery options 82 are selected for a message. Delivery options 90, 92, 94, 96, 98 and 100 enable the user to indicate thread recipient insertion/removal control settings.

The delivery options 82 in the illustrative embodiment of FIG. 3 include a “Request delivery receipt” option 84. If selected by the originating user 16, the “Request delivery receipt” option 84 causes a receipt confirmation message to be generated and sent back to the originating user 16 upon receipt of the message by each of the message recipients.

The delivery options 82 further include a “Request read receipt” option 86. If selected by the originating user 16, the “Request read receipt” option 86 causes a read receipt confirmation message to be generated and sent back to the originating user 16 upon the message being read by each of its recipients.

The delivery options 82 further include a “Prevent copying” option 88. If selected by the originating user 16, the “Prevent copying” option 88 prevents copying of the message by recipients of the message.

The delivery options 82 further include a “Prevent all thread recipient insertion” option 90. If selected by the originating user 16, the “Prevent all thread recipient insertion” option 90 prevents any recipients to be added to the set of recipients listed in the addressee fields 64 (FIG. 2) for purposes of replying to the message being composed using the user interface 50 (FIG. 2), or for purposes of otherwise adding a message in any way to the message thread based on the message being composed using the user interface 50.

The delivery options 82 further include a “Prevent insertion of the following users as thread recipients:” option 92. If selected by the originating user 16, the “Prevent insertion of the following users as thread recipients:” option 92 prevents any of the recipients listed by the originating user 16 in the delivery options user interface 80 from being added to the set of recipients listed in the addressee fields 64 (FIG. 2) for purposes of replying to the message being composed using the user interface 50 (FIG. 2), or for purposes of otherwise adding a message in any way to the message thread based on the message being composed using the user interface 50.

The delivery options 82 further include a “Prevent all thread recipient removal” option 94. If selected by the originating user 16, the “Prevent all thread recipient removal” option 94 prevents any recipients from being removed from the set of recipients listed in the addressee fields 64 (FIG. 2) for purposes of replying to the message being composed using the user interface 50 (FIG. 2), or for purposes of otherwise adding a message in any way to the message thread based on the message being composed using the user interface 50 (FIG. 2).

The delivery options 82 further include a “Prevent removal of the following thread recipients:” option 96. If selected by the originating user 16, the “Prevent removal of the following thread recipients:” option 96 prevents removal of the recipients listed by the originating user 16 in the delivery options user interface 80 from the set of recipients listed in the addressee fields 64 (FIG. 2) for purposes of replying to the message being composed using the user interface 50 (FIG. 2), or for purposes of otherwise adding a message in any way to the message thread based on the message being composed using the user interface 50 (FIG. 2).

The delivery options 82 further include a “Require approval for thread recipient insertion” option 98. If selected by the originating user 16, the “Require approval for thread recipient insertion” option 98 requires approval be obtained from the originating user 16 for any non-originating user to add a new recipient to those recipients listed by the originating user 16 in the addressee fields 64 (FIG. 2) for purposes of replying to the message being composed using the user interface 50 (FIG. 2), or for purposes of otherwise adding a message in any way to the message thread based on the message being composed using the user interface 50 (FIG. 2).

The delivery options 82 further include a “Require approval for thread recipient removal” option 100. If selected by the originating user 16, the “Require approval for thread recipient removal” option 100 requires approval be obtained from the originating user 16 for any non-originating user to remove a recipient from those recipients listed by the originating user 16 in the addressee fields 64 (FIG. 2) for purposes of replying to the message being composed using the user interface 50 (FIG. 2), or for purposes of otherwise adding a message in any way to the message thread based on the message being composed using the user interface 50 (FIG. 2).

An “OK” button 102 enables the originating user 16 to submit the selected ones of the delivery options 82 to be applied to the message being composed through the user interface 50 of FIG. 2.

During operation of the embodiment shown in FIGS. 2 and 3, if any one of the non-originating recipients Tom Albert, John White, and/or Bob Ross, generates a reply to the message being composed in the user interface 50, or to any subsequent message in the message thread based on the message composed through the user interface 50, their ability to add or remove recipients would be controlled based on thread recipient insertion/removal control settings indicated through the delivery options user interface 80. Accordingly, any attempt to add a recipient to such a message consisting of a user other than Tom Albert, John White, Bob Ross, or Sam Walters, would be controlled by the indicated thread recipient insertion/removal settings. Similarly, any attempt to remove one of the recipients Tom Albert, John White, Bob Ross or Sam Walters from the recipients of such a message would also be controlled by those thread recipient insertion/removal control settings.

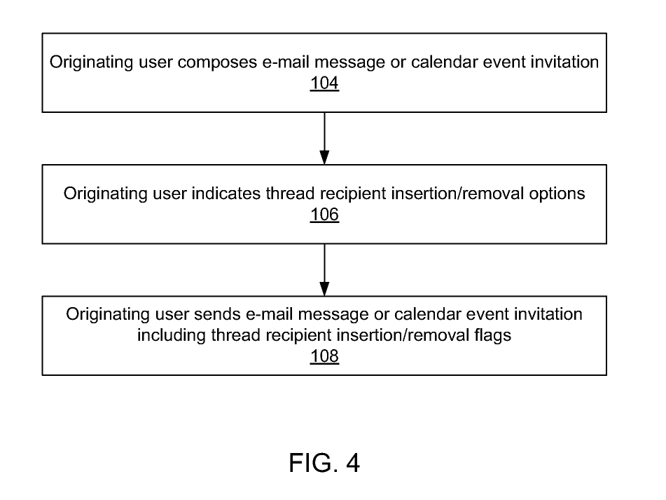

FIG. 4 is a flow chart showing steps performed to send a message including thread recipient insertion/deletion flags in an illustrative embodiment. In the illustrative embodiment of FIG. 1, the steps of FIG. 4 are performed by the originating user 16 through the user interface 14, in order to send the initial message 42.

As shown in FIG. 4, at step 104 the originating user composes an e-mail message or calendar event invitation message. Step 104 may, for example, be performed using the new message composition user interface 50 shown in FIG. 2. At step 106, the originating user indicates thread recipient insertion/removal options to be applied to the message. For example, the originating user may indicate thread recipient insertion/removal settings through the delivery options user interface 80 of FIG. 3. At step 108, the originating user sends the e-mail message or calendar event invitation including representations of the thread recipient insertion/removal settings indicated by the originating user at step 106. For example, at step 108 a message is sent such as the initial message 42 shown in FIG. 1. The representations of the thread recipient insertion/removal settings in the message sent at step 108 may, for example, be MIME flags set within the message, and corresponding to specific insertion/removal settings indicated by the originating user at step 106.

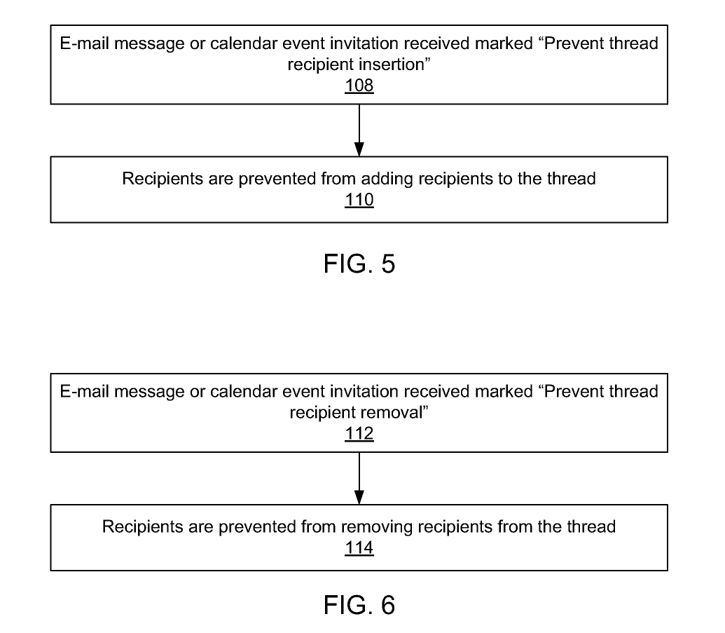

FIG. 5 is a flow chart showing steps performed to prevent thread recipient insertion in an illustrative embodiment of the disclosed system. For example, the steps of FIG. 5 may be performed by client software executing on the client system of a non-originating user, such as the client software 20, 28 or 36 shown in the illustrative embodiment of FIG. 1.

As shown in FIG. 5, at step 108 an e-mail message or calendar event invitation is received by one or more non-originating recipients, and includes an indication that recipients cannot be added to the list of recipients in the received message for messages in the message thread based on the received message. Accordingly, when a message recipient generates a reply to the received message, that reply must be addressed to no more than the sender of the message and all other recipients of the received message. Thus at step 110 message recipients are prevented from adding any new recipients to the original recipient list in the received message when generating a reply message, for example using a REPLY TO ALL function or the like in their client software.

FIG. 6 is a flow chart showing steps performed to prevent thread recipient removal in an illustrative embodiment of the disclosed system. For example, the steps of FIG. 6 may be performed by client software executing on the client system of a non-originating user, such as the client software 20, 28 or 36 shown in the illustrative embodiment of FIG. 1.

As shown in FIG. 6, at step 112 an e-mail message or calendar event invitation is received by one or more non-originating recipients, and includes an indication that recipients cannot be removed from the list of recipients in the received message for messages in the message thread based on the received message. Accordingly, when a message recipient generates a reply to the received message, that reply must be addressed to no less than the sender of the message and all other recipients of the received message. Thus at step 114 message recipients are prevented from removing any recipients from the original recipient list in the received message when generating a reply message, for example using a REPLY TO ALL function or the like in their client software.

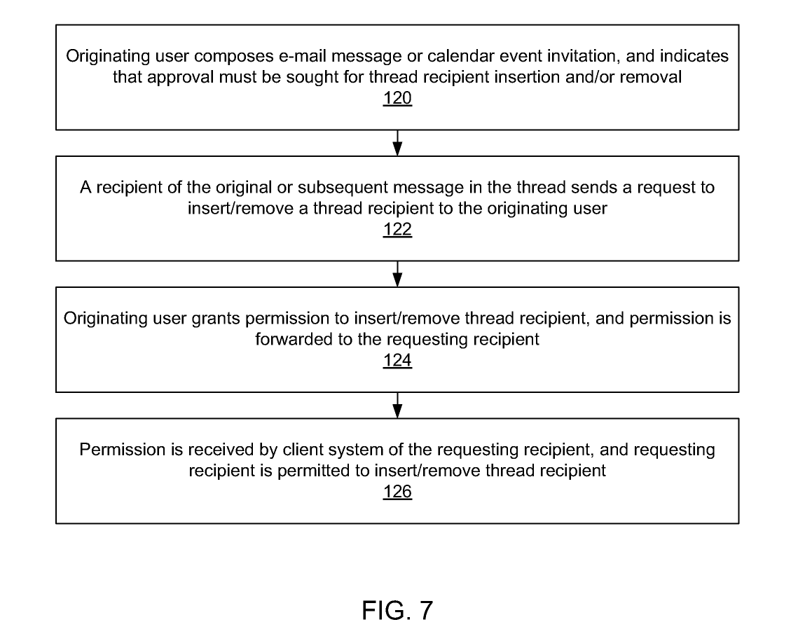

FIG. 7 is a flow chart showing steps performed to require recipients to seek permission to insert/remove thread recipients. At step 120, an originating user composes an e-mail message or calendar event invitation. The originating user indicates through the message composition user interface that approval must be sought from the originating user before a recipient can be added to or removed from the recipient list provided by the originating user. For example, the originating user may indicate that permission must be obtained before a recipient can be added to the message recipient list, that permission must be obtained before a recipient can be removed from the message recipient list, or that permission must be obtained before a recipient is either added to or removed from the message recipient list. Step 120 may, for example, be performed by the originating user 16 through the user interface 14 provided by the client software 12 in the client system 10.

At step 122, a recipient of the original message generated at step 120, or of a subsequent message in the message thread based on that original message, generates a reply message, e.g. through a REPLY TO ALL feature. The original message recipient also attempts send the reply message to a set of users other than the set of users in the list of recipients in the original message. For example, the original message recipient may attempt to remove a recipient from the list of recipients in the original message, or may attempt to add a recipient to the list of recipients in the original message. However, the client software (e.g. client software 20, 28 or 36 of FIG. 1) prevents the original message recipient from modifying the recipient list, based on the thread recipient insertion/removal control settings contained in the original message. For example, the recipient insertion/removal control settings may indicate that approval from the originating user must be obtained before additions and/or deletions can be made to the set of recipients. The client software accordingly sends a permission request message to the originating user, requesting permission to perform the addition to or removal from the recipient list.

At step 124, the originating user is presented with the permission request message, and is allowed to either grant or deny permission to make the requested modification to the recipient list. The originating user may be presented with the names of the recipient(s) that is/are to be removed from or added to the recipient list, and/or the name of the user requesting the recipient list modification. In the event that the originating user grants permission for the requested modification, then at step 124 a message granting the requested permission is conveyed back to the client software of the original message recipient that requested the permission. Otherwise, in the event that the originating user denies the requested permission, then at step 124 a message denying the requested permission is conveyed back to the client software of the original message recipient. For purposes of illustration, at step 124 in the FIG. 7 a message granting the requested permission is conveyed back to the client software of the recipient user that requested the permission.

At step 126, the client software of the recipient requesting permission to modify the recipient list receives the response to the request for permission to modify the recipient list. In the example of FIG. 7, the permission is granted, and the permission is received at step 126 to modify the recipient list. The client software of the recipient that requested permission to perform the modification to the recipient list then permits the requested modification operation (adding or removing a recipient) to be performed. In the event that the permission were denied, then at step 126 the client software of the recipient would prevent the requested modification operation from being performed.

The present invention can be realized in hardware, software, or a combination of hardware and software. A system according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable medium or memory that can direct a computer or other programmable data processing apparatus to function in a particular manner, such that the instructions stored in the computer-readable medium or memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for controlling the recipients of messages in a message thread, comprising:
enabling an originating user of said message thread to indicate whether recipients can be added to said message thread;
enabling said originating user of said message thread to indicate whether recipients can be removed from said message thread;
in the event said originating user indicates that recipients cannot be added to said message thread, preventing addition of recipients to said message thread; and
in the event said originating user indicates that recipients cannot be removed from said message thread, preventing removal of recipients from said message thread.

2. The method of claim 1, further comprising:
enabling said originating user to indicate whether permission to add recipients to said message thread can be sought from said originating user; and
in the event that said originating user indicates that permission to add recipients to said message thread can be sought, enabling a non-originating user to seek permission to add a new recipient to said message thread;
in response to said non-originating user seeking permission to add said new recipient to said message thread, sending an add request to said originating user, said add request indicating that said non-originating user has requested addition of said new recipient to said message thread;
enabling said originating user to accept said add request; and
in the event that said originating user accepts said add request, allowing said non-originating user to add said new recipient to said message thread.

3. The method of claim 2, further comprising:
enabling said originating user to deny said add request; and
in the event that said originating user denies said add request, preventing said non-originating user from adding said new recipient to said message thread.

4. The method of claim 3, further comprising:
enabling said originating user to indicate whether permission to remove recipients from said message thread can be sought from said originating user;
in the event that said originating user indicates that permission to remove recipients from said message thread can be sought, enabling a non-originating user to seek permission to remove a recipient from said message thread;
in response to said non-originating user seeking permission to remove said recipient from said message thread, sending a remove request to said originating user, said remove request indicating that said non-originating user has requested removal of said recipient from said message thread;
enabling said originating user to accept said remove request; and
in the event that said originating user accepts said remove request, allowing said non-originating user to remove said recipient to said message thread.

5. The method of claim 4, further comprising:
enabling said originating user to deny said remove request; and
in the event that said originating user denies said remove request, preventing said non-originating user from removing said new recipient from said message thread.

6. The method of claim 5, further comprising:
in the event said originating user indicates that recipients cannot be added to said message thread, storing a representation of said indication that recipients cannot be added to said message thread in an original message of said message thread; and
in the event said originating user indicates that recipients cannot be removed from said message thread, storing a representation of said indication that recipients cannot be removed from said message thread in an original message of said message thread.

7. The method of claim 6, further comprising:
enabling said originating user to indicate one or more users that cannot be added as recipients of said message thread;
enabling said originating user to indicate one or more recipients of said message thread that cannot be removed as recipients of said message thread;
preventing addition of said one or more users from being added as recipients of said message thread; and
preventing said one or more recipients from being removed as recipients of said message thread.

8. The method of claim 7, wherein said message thread is one of the set consisting of an electronic mail message thread and a calendar invitation message thread.

9. A system including a computer readable medium, said computer readable medium having stored thereon program code for controlling the recipients of messages in a message thread, said program code comprising:
program code for enabling an originating user of said message thread to indicate whether recipients can be added to said message thread;
program code for enabling said originating user of said message thread to indicate whether recipients can be removed from said message thread;
program code for, in the event said originating user indicates that recipients cannot be added to said message thread, preventing addition of recipients to said message thread; and
program code for, in the event said originating user indicates that recipients cannot be removed from said message thread, preventing removal of recipients from said message thread.

10. The system of claim 9, said program code further comprising:
program code for enabling said originating user to indicate whether permission to add recipients to said message thread can be sought from said originating user; and
program code for, in the event that said originating user indicates that permission to add recipients to said message thread can be sought, enabling a non-originating user to seek permission to add a new recipient to said message thread;
program code for, in response to said non-originating user seeking permission to add said new recipient to said message thread, sending an add request to said originating user, said add request indicating that said non-originating user has requested addition of said new recipient to said message thread;
program code for enabling said originating user to accept said add request; and
program code for, in the event that said originating user accepts said add request, allowing said non-originating user to add said new recipient to said message thread.

11. The system of claim 10, said program code further comprising:
program code for enabling said originating user to deny said add request; and
program code for, in the event that said originating user denies said add request, preventing said non-originating user from adding said new recipient to said message thread.

12. The system of claim 11, said program code further comprising:
program code for enabling said originating user to indicate whether permission to remove recipients from said message thread can be sought from said originating user;
program code for, in the event that said originating user indicates that permission to remove recipients from said message thread can be sought, enabling a non-originating user to seek permission to remove a recipient from said message thread;
program code for, in response to said non-originating user seeking permission to remove said recipient from said message thread, sending a remove request to said originating user, said remove request indicating that said non-originating user has requested removal of said recipient from said message thread;
program code for enabling said originating user to accept said remove request; and
program code for, in the event that said originating user accepts said remove request, allowing said non-originating user to remove said recipient to said message thread.

13. The system of claim 12, said program code further comprising:
program code for enabling said originating user to deny said remove request; and
program code for, in the event that said originating user denies said remove request, preventing said non-originating user from removing said new recipient from said message thread.

14. The system of claim 13, said program code further comprising:
program code for, in the event said originating user indicates that recipients cannot be added to said message thread, storing a representation of said indication that recipients cannot be added to said message thread in an original message of said message thread; and
program code for, in the event said originating user indicates that recipients cannot be removed from said message thread, storing a representation of said indication that recipients cannot be removed from said message thread in an original message of said message thread.

15. The system of claim 14, said program code further comprising:
program code for enabling said originating user to indicate one or more users that cannot be added as recipients of said message thread;
program code for enabling said originating user to indicate one or more recipients of said message thread that cannot be removed as recipients of said message thread;
program code for preventing addition of said one or more users from being added as recipients of said message thread; and
program code for preventing said one or more recipients from being removed as recipients of said message thread.

16. The system of claim 15, wherein said message thread is one of the set consisting of an electronic mail message thread and a calendar invitation message thread.

17. A computer program product including a computer readable medium, said computer readable medium having stored thereon program code for controlling the recipients of messages in a message thread, said program code comprising:
program code for enabling an originating user of said message thread to indicate whether recipients can be added to said message thread;
program code for enabling said originating user of said message thread to indicate whether recipients can be removed from said message thread;
program code for, in the event said originating user indicates that recipients cannot be added to said message thread, preventing addition of recipients to said message thread; and
program code for, in the event said originating user indicates that recipients cannot be removed from said message thread, preventing removal of recipients from said message thread.

18. A computer data signal embodied in a carrier wave, said computer data signal having stored thereon program code for controlling the recipients of messages in a message thread, said program code comprising:
program code for enabling an originating user of said message thread to indicate whether recipients can be added to said message thread;
program code for enabling said originating user of said message thread to indicate whether recipients can be removed from said message thread;
program code for, in the event said originating user indicates that recipients cannot be added to said message thread, preventing addition of recipients to said message thread; and
program code for, in the event said originating user indicates that recipients cannot be removed from said message thread, preventing removal of recipients from said message thread.

19. A system for controlling the recipients of messages in a message thread, comprising:
means for enabling an originating user of said message thread to indicate whether recipients can be added to said message thread;
means for enabling said originating user of said message thread to indicate whether recipients can be removed from said message thread;
means for, in the event said originating user indicates that recipients cannot be added to said message thread, preventing addition of recipients to said message thread; and
means for, in the event said originating user indicates that recipients cannot be removed from said message thread, preventing removal of recipients from said message thread.
